(19) United States
(12) Patent Application Publication
(10) Pub. No.: US 2026/0334536 A1
(43) Pub. Date: Oct. 29, 2026

(54) CIGAR HOLDING APPARATUS

(71) Applicant: Lyle Bernhardt Murphey, Corpus Christi, TX (US)

(72) Inventor: Lyle Bernhardt Murphey, Corpus Christi, TX (US)

(21) Appl. No.: 19/657,460

(22) Filed: Apr. 24, 2026

Related U.S. Application Data
(60) Provisional application No. 63/794,178, filed on Apr. 24, 2025.

(51) Int. Cl. A24F 13/22; A24F 13/02; F16M 13/02

(52) U.S. Cl. CPC A24F 13/22; A24F 13/02; F16M 13/022

(57) ABSTRACT

A cigar holding apparatus includes a flexible hook-and-loop fastener strap having a hooked fastener surface on a front face and a looped fastener surface on a rear face. At least one strap slot is defined through the strap and is configured to receive a tapered end of the strap to form an adjustable, infinitely variable loop. A neodymium magnet is affixed to an outer surface of the strap by heat-shrink tubing encapsulating both the magnet and a corresponding portion of the strap. When looped around a cigar and fastened, the apparatus gently retains the cigar without marring the wrapper. The magnet adheres to ferromagnetic metal surfaces, such as a golf cart upright, to temporarily secure the cigar and free the user's hands. The apparatus is lightweight, reusable, and accommodates cigars of varying ring gauges without modification.

### CROSS-REFERENCE TO RELATED APPLICATION

This application claims the benefit of, and priority to, U.S. Provisional Patent Application Ser. No. 63/794,178, filed Apr. 24, 2025, entitled “Cigar Holding Apparatus,” the entire disclosure of which is incorporated herein by reference.

### FIELD OF THE INVENTION

The present invention relates generally to cigar accessories, and more particularly to an adjustable wearable band apparatus that secures a cigar to a metal surface, freeing the user's hands during use.

### BACKGROUND OF THE INVENTION

Cigar smokers frequently encounter situations in which they desire to temporarily set down or secure a lit or unlit cigar while attending to other activities, such as playing golf, cooking outdoors, or performing manual tasks. Conventional cigar holders—including clamp-style holders, ashtrays, and clip accessories—are typically rigid, non-adjustable, and designed for stationary use on flat surfaces.

Existing wearable or attachable cigar accessories have several shortcomings. Many are constructed of hard materials that can mar the wrapper of a premium cigar. Others employ a single fixed-size opening that cannot accommodate cigars of varying ring gauges. Still others lack any means of attaching to a metal object, requiring the user to rest a lit cigar on an unstable surface or hold it between the fingers continuously.

Magnetic cigar holders known in the art tend to use rigid clamps or brackets, making them uncomfortable to handle and difficult to secure snugly around a cigar without damaging the wrapper. Additionally, the magnetic force provided by such prior-art devices is often insufficient to reliably retain a cigar against a vertical or overhead metal surface under real-world conditions.

Accordingly, there exists a need for a soft, infinitely adjustable cigar-holding band that can conform to any ring gauge, gently cradle the cigar wrapper without marring it, and incorporate a sufficiently powerful magnet to adhere reliably to metal objects such as the frame of a golf cart or a golf club shaft.

### SUMMARY OF THE INVENTION

The present invention provides a cigar holding apparatus comprising a flexible hook-and-loop fastener strap and a magnet assembly secured to the strap by a length of heat-shrink tubing. The strap includes a hooked fastener surface on a first portion and a looped fastener surface on a second portion and defines one or more strap slots through which the strap may be threaded to form an adjustable loop. The adjustable loop is sized to receive and retain a cigar of any ring gauge while conforming gently to the cigar's wrapper without causing damage.

The magnet assembly incorporates a neodymium magnet of sufficient field strength to adhere to metal objects—including tubular or curved metal surfaces such as golf cart frames, tool chests, barbecue grills, and similar metal structures—when the apparatus is worn around a cigar. The magnet is encapsulated within heat-shrink tubing that also secures the magnet to the strap, providing a compact, low-profile attachment.

In one aspect, the invention provides a method of temporarily securing a cigar to a metal surface comprising the steps of: looping the strap around the cigar; engaging the hook fastener surface to the loop fastener surface to form a snug, adjustable fit; and pressing the magnet assembly against a ferromagnetic surface to adhere the cigar-laden apparatus thereto.

The apparatus is lightweight, reusable, washable, and accommodates cigars across a wide range of ring gauges without modification, affording convenience to golfers, outdoor enthusiasts, and cigar aficionados generally.

These and other features, aspects and advantages of the present invention will become better understood with reference to the following drawings, description and claims.

### BRIEF DESCRIPTION OF THE DRAWINGS

The accompanying drawings, which are incorporated in and constitute a part of this specification, illustrate embodiments of the invention and, together with the description, serve to explain the principles of the invention. In the drawings:

FIG. 1 is a front perspective view of the cigar holding apparatus shown engaged around an exemplary cigar;

FIG. 2 is a front perspective view of the cigar holding apparatus shown in a flat, unlooped configuration;

FIG. 3 is a rear perspective view of the cigar holding apparatus shown in a flat, unlooped configuration;

FIG. 4 is a perspective view of the cigar holding apparatus shown in a wrapped configuration;

FIG. 5 is a top plan view of the cigar holding apparatus wrapped around an exemplary cigar;

FIG. 6 is a cross-sectional view of the cigar holding apparatus taken along line 6-6 of FIG. 5; and

FIG. 7 is a rear perspective view of the cigar holding apparatus shown retaining a cigar against the upright of a golf cart.

### DETAILED DESCRIPTION OF THE INVENTION

The following detailed description sets forth specific embodiments of the invention in sufficient detail to enable a person of ordinary skill in the art to practice the invention. It will be apparent that modifications and variations are possible without departing from the scope of the invention as defined in the appended claims. The following description is, therefore, not to be taken in a limiting sense.

Referring now to the drawings, in which like reference numerals identify like elements throughout the several views, a cigar holding apparatus 10 according to a preferred embodiment of the invention is illustrated.

### A. Overview of the Apparatus

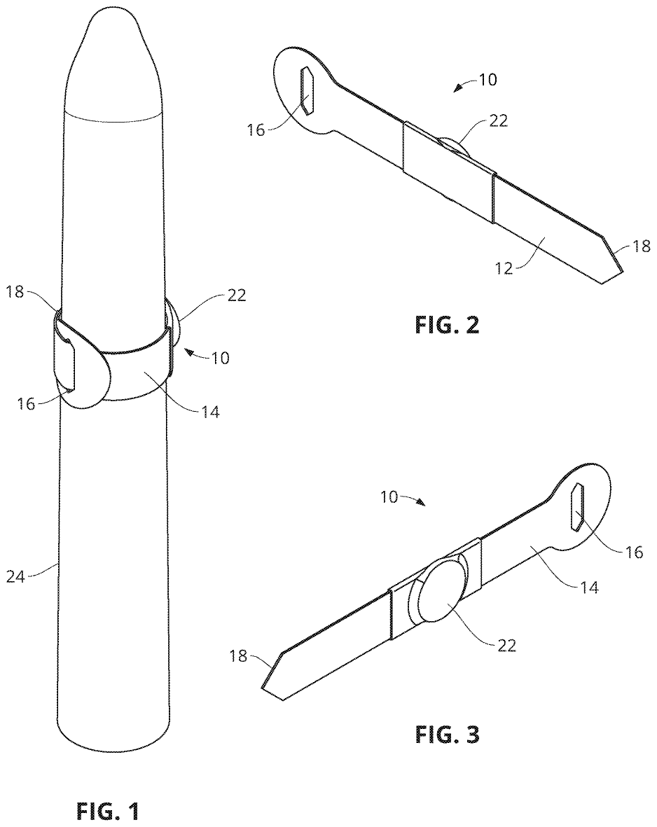

As shown in FIGS. 1-7, the cigar holding apparatus 10 comprises a strap assembly having a hooked fastener strap front portion 12, a looped fastener strap rear portion 14, one or more strap slots 16, a tapered end 18, a magnet 20, and heat-shrink tubing 22. An exemplary cigar 24 is depicted in certain figures for illustrative purposes only.

### B. Strap Assembly

Referring to FIGS. 2 and 3, the strap is a flexible, elongated band of hook-and-loop fastener material. The front face of the strap defines a hooked fastener surface 12 along at least a portion of its length, while the rear face of the strap defines a looped fastener surface 14. In the illustrated embodiment, the front and rear faces carry complementary hook-and-loop (i.e., VELCRO®-type) material such that the strap can be releasably fastened to itself when the strap is looped around an object.

The strap includes one or more strap slots 16 formed therethrough. As shown in FIGS. 1, 2, and 3, the strap slots 16 provide openings through which the tapered end 18 of the strap may be threaded to adjust the effective loop diameter. The tapered end 18 facilitates threading through the strap slots 16 and allows smooth, stepless adjustment of the loop circumference to accommodate cigars of varying ring gauges. The strap material is soft and pliable such that, when looped around a cigar 24 and fastened, it conforms to the outer surface of the cigar without marring the wrapper.

### C. Magnet Assembly

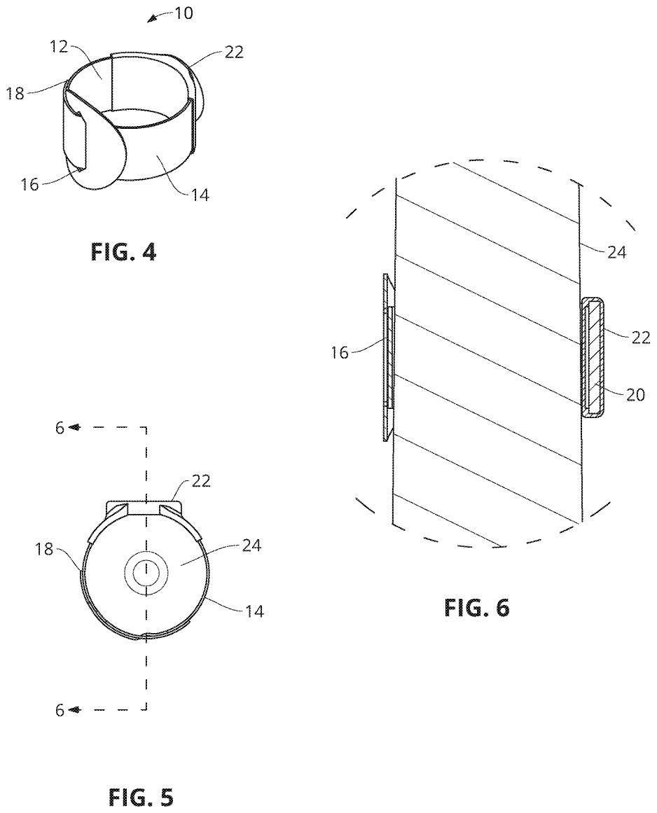

As depicted in FIGS. 4, 5, and 6, the magnet 20 is secured to the strap assembly by means of the heat-shrink tubing 22. In the preferred embodiment, the magnet 20 is a neodymium (rare-earth) magnet having a field strength sufficient to adhere to ferromagnetic metal surfaces, including curved tubular surfaces, under the combined weight of the apparatus 10 and a cigar 24. Neodymium magnets are preferred for their high magnetic flux density relative to their size and weight.

The heat-shrink tubing 22 is placed over and around the magnet 20 and a corresponding portion of the strap, and then subjected to heat until the tubing shrinks tightly around both the magnet 20 and the strap, thereby mechanically bonding the magnet 20 to the strap in a low-profile, secure manner. The resulting assembly presents a smooth outer surface that does not snag on cigar wrappers or clothing.

As shown in the cross-sectional view of FIG. 6, the magnet 20 is positioned on the outer face of the strap so that, when the apparatus 10 is looped around a cigar 24, the magnet 20 faces outward and is available to engage a ferromagnetic surface.

### D. Use of the Apparatus

In operation, the user threads the tapered end 18 of the strap through the one or more strap slots 16 and loops the strap around a cigar 24 with a desired degree of snugness. The hooked fastener surface 12 is then pressed against the looped fastener surface 14 to releasably engage the two surfaces and fix the loop circumference. The resulting loop securely retains the cigar 24 within the apparatus 10.

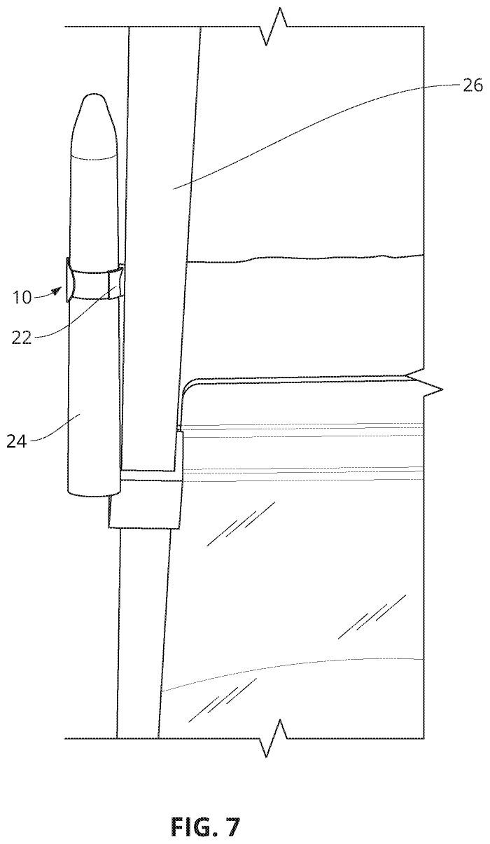

The user then presses the magnet 20 against any convenient ferromagnetic metal surface. As illustrated in FIG. 7, the apparatus 10 may be used to attach the cigar 24 to a golf cart upright 26, thereby freeing the user's hands during play. The magnetic attraction between the magnet 20 and the metal upright 26 is sufficient to support the combined weight of the apparatus 10 and the cigar 24 against a vertical surface.

To remove the cigar 24, the user simply pulls the apparatus 10 away from the metal surface, overcoming the magnetic attraction, and then disengages the hooked fastener surface 12 from the looped fastener surface 14 to open the loop and release the cigar. The apparatus 10 may be reused indefinitely.

### E. Alternative Embodiments

While the preferred embodiment employs a single neodymium magnet 20, alternative embodiments may employ a plurality of magnets arranged along the length of the strap to increase magnetic holding force or to permit attachment to non-flat metal surfaces. In still other embodiments, the magnet may be removably secured to the strap rather than permanently affixed, allowing the user to replace a magnet that has lost strength over time.

The strap may be fabricated in a variety of widths and lengths to accommodate cigars of different ring gauges and lengths. The strap material may comprise any suitable hook-and-loop fastener material. The heat-shrink tubing 22 may be replaced by other encapsulating means, such as adhesive bonding, stitching, riveting, or overmolding, provided that the selected means secures the magnet 20 firmly to the strap.

In yet another embodiment, the apparatus may omit the heat-shrink tubing entirely, with the magnet 20 being bonded directly to the strap material using an adhesive or by being integrally formed within the strap.

The apparatus is not limited to use with cigars and may be adapted to hold other cylindrical or similarly shaped objects against ferromagnetic surfaces. For example, the apparatus could hold a flashlight, a tool handle, or a beverage container.

It should be understood, of course, that the foregoing relates to exemplary embodiments of the invention and that modifications may be made without departing from the spirit and scope of the invention as set forth in the following claims.

What is claimed is:

1. A cigar holding apparatus comprising:
a flexible strap having a first end, a second end, a front face, and a rear face, wherein the front face includes a hooked fastener surface and the rear face includes a looped fastener surface, the hooked fastener surface and the looped fastener surface being configured to releasably engage one another;
at least one strap slot defined through the strap and configured to receive the second end of the strap therethrough to form an adjustable loop;
a magnet disposed on the strap; and
heat-shrink tubing encapsulating at least a portion of the magnet and a corresponding portion of the strap, thereby securing the magnet to the strap.

2. The apparatus of claim 1, wherein the magnet is a neodymium magnet.

3. The apparatus of claim 1, wherein the at least one strap slot comprises two or more strap slots spaced along the length of the strap.

4. The apparatus of claim 1, wherein the second end of the strap is tapered to facilitate threading through the at least one strap slot.

5. The apparatus of claim 1, wherein the magnet is positioned on an outer surface of the strap such that, when the adjustable loop is formed around an object, the magnet faces outwardly away from the object.

6. The apparatus of claim 1, wherein the adjustable loop is configured to receive and retain a cigar of varying ring gauge.

7. The apparatus of claim 1, wherein the strap is fabricated from a soft, pliable material configured to conform to an outer surface of a cigar without marring a cigar wrapper.

8. The apparatus of claim 2, wherein the neodymium magnet has sufficient magnetic field strength to adhere the apparatus and a cigar retained therein to a vertical ferromagnetic metal surface.

9. A cigar holding apparatus comprising:
an elongated flexible band of hook-and-loop fastener material having a hooked fastener surface on a first face and a looped fastener surface on a second face;
at least one slot defined through the band configured to form an adjustable loop when an end of the band is threaded therethrough and the hooked fastener surface is engaged with the looped fastener surface; and
a rare-earth magnet affixed to an outer surface of the band by encapsulating heat-shrink tubing.

10. The apparatus of claim 9, wherein the rare-earth magnet is a neodymium magnet.

11. The apparatus of claim 9, wherein the end of the band is tapered to facilitate threading through the at least one slot.

12. The apparatus of claim 9, wherein the adjustable loop is infinitely adjustable within a range of loop circumferences without discrete steps.

13. The apparatus of claim 9, wherein the rare-earth magnet is positioned on the band such that an exposed face of the magnet faces outwardly when the adjustable loop is disposed around an object.

14. The apparatus of claim 1, wherein a plurality of magnets are disposed on the strap and are each secured by the heat-shrink tubing.

15. The apparatus of claim 9, wherein the hook-and-loop fastener material is soft and pliable such that the adjustable loop conforms to and supports a cigar without marring the cigar's wrapper.

16. The apparatus of claim 1, wherein the strap is sized to extend around a cigar and has a width substantially corresponding to a width of a cigar band.
